(19) United States
(12) Patent Application Publication
(10) Pub. No.: US 2015/0298945 A1
(43) Pub. Date: Oct. 22, 2015

(54) Breakaway Pulley

(71) Applicant: Andrew Fayal, Nine Mile Falls, WA (US)

(72) Inventor: Andrew Fayal, Nine Mile Falls, WA (US)

(21) Appl. No.: 14/566,388

(22) Filed: Dec. 10, 2014

Related U.S. Application Data
(60) Provisional application No. 61/914,310, filed on Dec. 10, 2013.

(51) Int. Cl. B66D 3/04

(52) U.S. Cl. CPC B66D 3/046

(57) ABSTRACT

A breakaway pulley which opens and releases enclosed line when a knot in the line passes into the pulley. The pulley has two plates which are attached to each other by a hinge, with the hinge having a spring which urges the two plates apart. A pulley is on one plate, and a point of attachment is on the other pulley. The two plates are secured at the second end by a locking tooth which engages a notch, and which is released from engagement when the knot enters the pulley.

### PRIORITY/CROSS-REFERENCE TO RELATED APPLICATIONS

This application claims the benefit of U.S. Provisional Application No. 61/914,310, filed Dec. 10, 2013, the disclosure of which is incorporated by reference.

### TECHNICAL FIELD

The presently disclosed and claimed technology generally relates to pulleys, and more particularly to pulleys which can be set to open when the operator desires, thus releasing the line from the pulley

### BACKGROUND

In bomb removal operations in the field, it is sometimes desirable to drag a suspected bomb for a distance in order to move it from one point to another. Sometimes it is desired to drag the suspected explosive in a straight line, but at other times it is desired to drag the suspected bomb at several different angles in order to move it around obstacles or to a preferred location. To allow this kind of multi angled dragging operation to occur, in situations where a multi angled drag is desired, a device called a breakaway pulley is utilized. The breakaway pulley serves as a line handling pulley until the load approaches the pulley. Typically a wedge is clamped onto the line, by use of tools, and as the wedge enters the pulley it springs the pulley apart and releases the line. In this manner the load can be pulled toward an anchor point on which the pulley is attached, then the pulley can be released and the line pulling the load can pull it in a different direction. In this way, the load can be pulled in a zig zag path until it reaches the preferred location of the suspected explosive. The problem with the use of wedges in breakaway pulleys is that it requires the use of tools and small parts which can be lost, and when the wedge is clamped to a line, a wedge can slip on the line and fail to release the pulley when it is desired. What is preferable is to use a breakaway pulley which does not need the use of wedges to open the pulley, and which automatically springs the pulley open and releases a line.

### SUMMARY

Disclosed is a pulley device for use in tactical situations, particularly in bomb-removal applications. The pulley accommodates a line or rope, which is attached to something desired to be pulled or dragged, like a suspected bomb. The pulley device opens to release the line when a knot in the line contacts a mechanism in the pulley device. Combining a number of these pulleys, one is able to move something by a line over a non-linear path. As the knot in the line reaches each pulley, that pulley gives way and allows the line to move at another angle toward the next change of direction. The invention, unlike prior tactical pulleys, does not require an additional piece of equipment (like a line-mounted wedge or cone) to operate the pulley device's release mechanism.

The tactical breakaway pulley is made to be carried in a tactical assault load of equipment. With minimal space and weight, this pulley allows the operator a single change in direction for each pulley used. It does not require a wedge to release the pulley. All that is needed is a simple knot to be tied into the line at the desired breakaway distance from the pulley. When the knot reaches the pulley, it automatically opens the pulley and the direction of pull can be changed as the load is pulled toward the next pulley in the route. This allows a load to be pulled in a non-linear path. There are no extra parts required, and no extra mechanical devices needed to reset the pulley, other than putting the line back in and closing the hinged sides of the pulley. The closure is spring loaded and automatically resets once closed.

The device is made to work with ⅛″ Amsteel spectron Kevlar line.

The device can pull over 200 pounds and still be able to break away.

It is 2½″ in length, 1.25″ in width, and 0.6″ in height. The steel version weighs 0.5 pounds, and the titanium version weighs 0.2 pounds. It has a maximum pull weight of over 200 pounds, with the maximum not having been determined yet.

The breakaway pulley is made up of a first and a second plate which are hinged together and are openable and closeable in an opened and a closed position. The first plate has a first end a second end and has attached to it a generally circular pulley which is configured for rotation in a plane of rotation parallel with the plane of the first plate. The pulley has a line securing groove in a circumferal edge of the pulley. The first plate has a notch in the second end of the plate for securing a locking tooth of the second plate. The second plate is also planar and generally rectangular and is hingedly attached to the first end of the first plate. The second plate has a slider block on the second end and a locking spring which presses against the slider block and presses the slider block towards the first end of the second plate. Attached to the slider block is a locking tooth which engages a notch in the second end of the first block. The slider block is configured to slide along the second plate toward the first end of the second plate. The second plate also has an attachment point on the second end of the second plate, which typically would be a tab with a hole in it to which a line is attached which secures the second plate to an anchor position. The anchor point could be a pole, a tree, a rock, or any other stationary object. The attachment point can be attached to the anchor point by any number of convenient devices, such as string, rope, cord, wire, or a stake driven into the ground.

The first and second plates are joined together by a hinge, and the hinge includes an internal spring which causes the plates to move away from each other. When the plates are joined to each other, they are joined at both the first end and the second end, and when they are in the open position they are only joined at the first ends of each plate, where the hinge in present. The breakaway pulley includes a line which passes over the pulley when the two plates are joined together, and fits in the line securing groove on the edge of the pulley and is adjacent to the slider block on the second end of the second plate. A locking hook is attached to the slider block, and the slider block is urged toward the pulley by a locking spring. A knot is placed in the cord at a point where the pulley is meant to be released, and as the knot enters the space between the pulley and the slider block, the slider block is pushed toward the second end of the second plate, which releases the locking tooth from the notch of the first plate, and allows the hinge spring to force the two plates apart. As the two plates are forced apart, the line is released from the pulley and is no longer attached to the pulley.

### BRIEF DESCRIPTION OF THE DRAWINGS

FIG. 1 is a perspective view of the disclosed breakaway pulley in the open position.

FIG. 2 is a perspective view of the disclosed breakaway pulley in the open position.

FIG. 3 is a perspective view of the disclosed breakaway pulley in the open position.

FIG. 4 is a perspective view of the disclosed breakaway pulley in the closed position.

FIG. 5 is a perspective view of the disclosed breakaway pulley in the closed position with a cord in place.

FIG. 6 is a perspective view of the disclosed breakaway pulley in the closed position with a cord and a knot.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

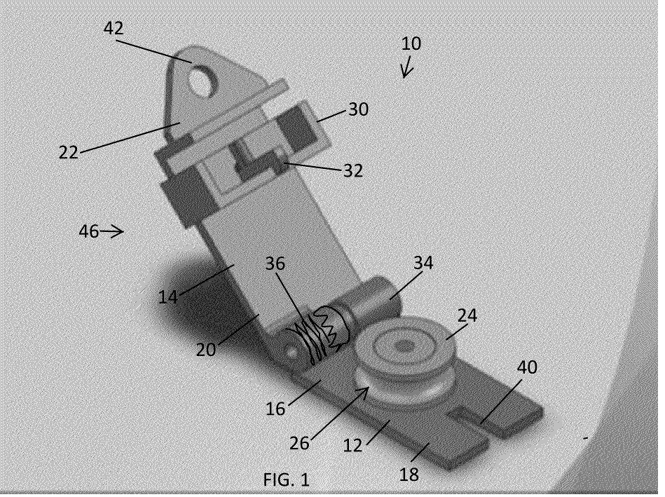

Certain preferred embodiments of the disclosed technology are shown in FIGS. 1 through 6. FIG. 1 shows the breakaway pulley 10 of the disclosed technology, which is comprised of a first plate 12 and a second plate 14. The first plate 12 has a first end 16 and a second end 18. The second plate 14 has a first end 20 and a second end 22. A pulley 24 is rotatably attached on the first plate 12 and has a line engaging groove 26 through which a line 28 passes. The first plate 12 has a notch 40 which is provided for engagement of a locking tooth 32 which is on the second plate 14. The first plate 12 is attached to the second plate 14 at both of the plate's first ends by a hinge 34. Internally to the hinge is a hinge spring 36, which urges the first and second plates apart. An external spring would also work in this application.

The second plate 14 has a slider block 30 to which is attached a locking spring 28 which urges the slider block 30 towards the first end 20 of the second plate 14. The second plate 14 also has an attachment point 42 which would typically be a hole in a tab to allow the second plate 14 to be attached to an anchor point. As noted above, the anchor point can be a tree, rock, stake in the ground, stake through the hole on the second end of the second plate, or any other stationary object.

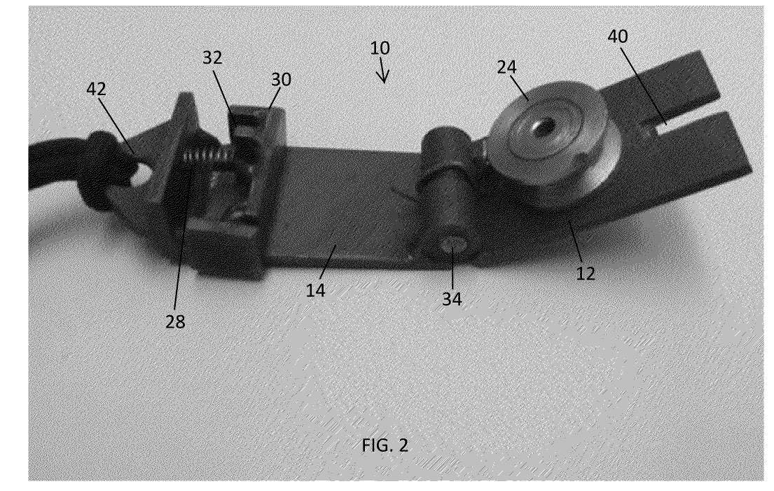

FIG. 2 shows a different view of the parts of the breakaway pulley 10. It shows more clearly the locking spring 28, slider block 30, the locking tooth 32, all of these on the second plate 14. Shown on the first plate 12 are the pulley 24 and the notch 40. The two plates are held together at their first end by the hinge 34.

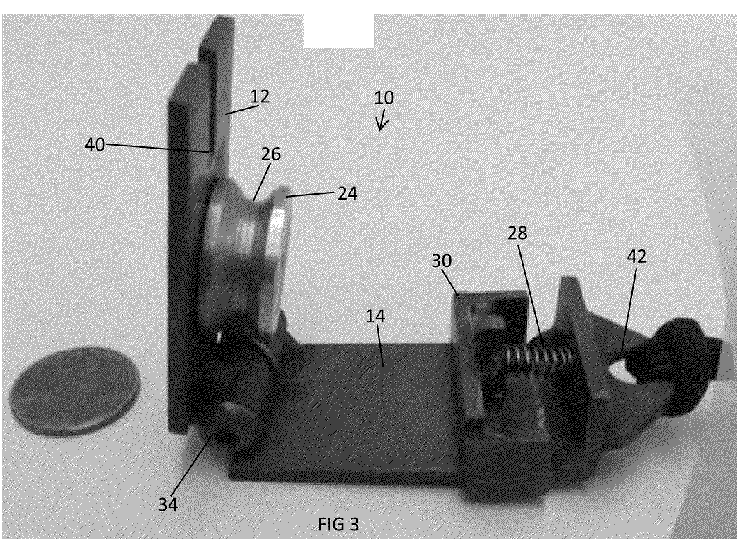

FIG. 3 shows a different view of the parts of the invention with the two plates in an open position, in which the line would be released from the pulley.

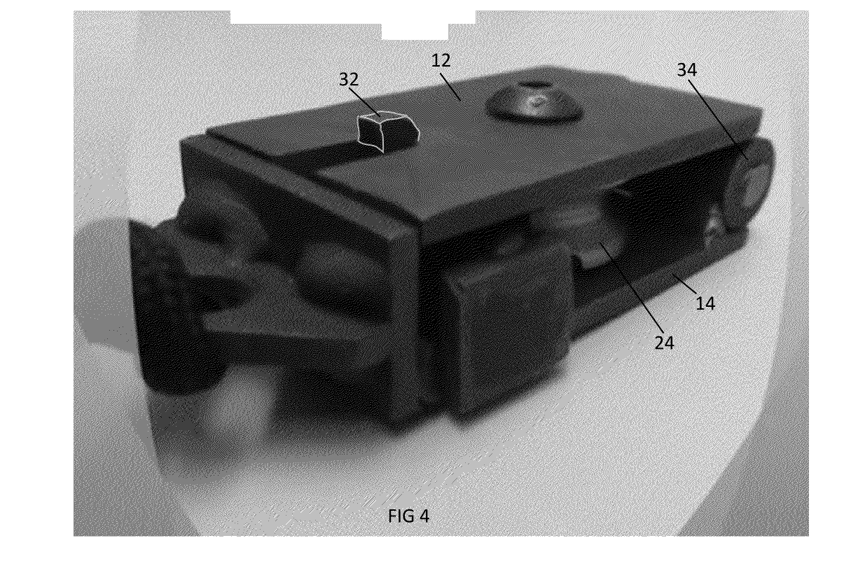

FIG. 4 shows the two plates in a closed position 44. The two plates are held together in the closed position by the locking tooth 32 engaging the notch 40 and holding the two plates together.

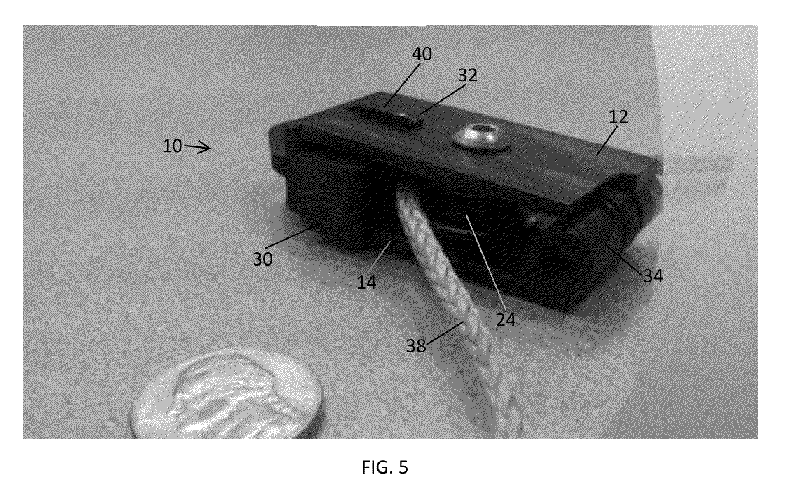

FIG. 5 shows the two plates in a closed position with a line 38 passing through the breakaway pulley 10 between the pulley and the slider block 30.

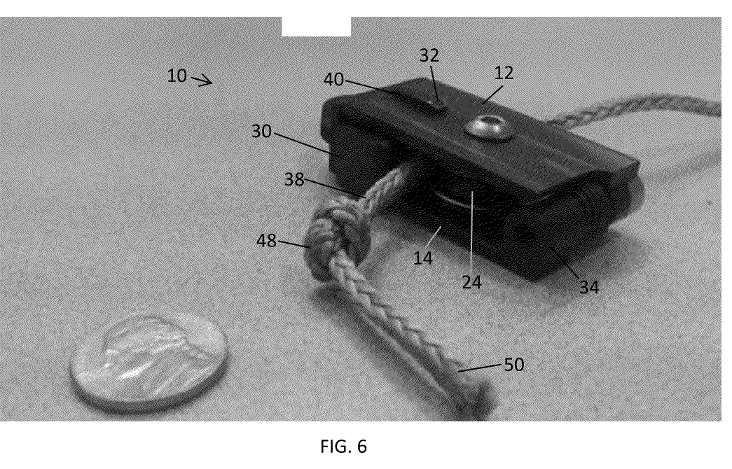

FIG. 6 shows the breakaway pulley 10 in a closed position, with the line having a knot 48 tied in the line 38, which as it is pulled through the pulley would force the slider block 30 away from the pulley, and disengage the locking tooth 32 from the notch 40, thus springing the breakaway pulley open and releasing the line at the intended point. The load would be attached to the end of the line 50. Once a first breakaway pulley opened, the line would pull the load (not shown) in a different direction, potentially to a second breakaway pulley and potentially to a third, fourth or more breakaway pulleys until the load is dragged to the preferred position.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

I claim:

1. A breakaway pulley for attachment to a load to be pulled toward an anchor point, said breakaway pulley comprised of
a generally planar first plate with a first end and a second end, with a generally circular pulley rotatably mounted on the first plate, with said pulley having a plane of rotation parallel with the plane of the first plate, with said pulley having a line securing groove in a circumferencial edge of side pulley, with said first plate defining a notch in said second end for securing a locking tooth of a second plate;
a generally planar second plate having a first and a second end, hingedly attached to said first plate at said first end, said second plate having a locking spring and a slider block on said second end, said slider block configured to slide along said second plate and having a locking spring urging said slider block toward said first end of said second plate, and said slider block further comprising a locking hook, said locking tooth configured to engage with said notch in said first plate, said second plate further defining an attachment point on said second end, for securing said breakaway pulley to an anchor point in the field of use;
a hinge joining said first and second plates, with a hinge spring in said hinge which urges said plates to move from a closed to an open position, with said locking hook in said second plate engaged with said notch in said first plate in said closed position, and with said plates joined only at said hinge in said open position;
a line attachable to a load, said line passing over said pulley in said line securing groove adjacent to said slider block on the second end of said second plate; wherein a knot in said line when pulled between said pulley edge and said sliding block, presses said sliding block toward said second end of said second plate against said locking spring, and releases said locking hook on said second plate from said notch in said first plate, allowing said plates to move from a closed position to an open position, thus disengaging said line from said pulley.

2. The breakaway pulley of claim 1, in which said attachment point is a passage defined in an extension of said second plate, for attachment of said breakaway pulley to a stationary object.

3. The breakaway pulley of claim 1, in which said notch is a rectangular opening defined in said first plate.

4. The breakaway pulley of claim 1, in which said slider block is at least as wide as said second plate.
